(19) United States
(12) Patent Application Publication
(10) Pub. No.: US 2026/0005814 A1
(43) Pub. Date: Jan. 1, 2026

(54) TYPE I CODEBOOK ENHANCEMENT

(71) Applicant: Apple Inc., Cupertino, CA (US)

(72) Inventors: Haitong Sun, Cupertino, CA (US); Ankit Bhamri, Bad Nauheim (DE); Chunxuan Ye, San Diego, CA (US); Dawei Zhang, Saratoga, CA (US); Huaning Niu, San Jose, CA (US); Jie Cui, San Jose, CA (US); Wei Zeng, Saratoga, CA (US); Weidong Yang, San Diego, CA (US)

(21) Appl. No.: 19/322,422

(22) Filed: Sep. 8, 2025

Related U.S. Application Data
(62) Division of application No. 19/172,627, filed on Apr. 7, 2025.
(60) Provisional application No. 63/645,741, filed on May 10, 2024.

(51) Int. Cl. H04L 5/00; H04B 7/0456

(52) U.S. Cl. CPC H04L 5/0051; H04B 7/0456

(57) ABSTRACT

Disclosed are methods, systems, and computer-readable medium to perform operations that include receiving a channel state information reference signal (CSI-RS), and in response to receiving the CSI-RS, estimating CSI using a type I codebook. The type I codebook corresponds to a plurality of panels, and each panel of the plurality of panels corresponds to one CSI-RS resource.

### CROSS-REFERENCE TO RELATED APPLICATIONS

This application is a divisional patent application of and claims priority to U.S. patent application Ser. No. 19/172,627, filed Apr. 7, 2025, which claims priority to U.S. Provisional Patent Application No. 63/645,741, filed May 10, 2024, entitled “TYPE I CODEBOOK ENHANCEMENT,” the disclosure of each of which are considered part of the disclosure of this application, and are incorporated by reference in its entirety into this application.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

A Type I codebook refers to a set of predefined beamforming vectors or matrices used by a transmitter (e.g., a base station, an access node, or gNodeB (gNB)) to spatially multiplex data streams to multiple users or transmit signals to multiple antenna ports. Each beamforming vector or matrix in the Type I codebook corresponds to a specific beamforming pattern that can be used to focus the transmitted energy in a particular direction or spatial domain. By selecting appropriate beamforming vectors/matrices from the codebook, the transmitter can optimize signal transmission to achieve desired objectives, such as maximizing signal strength at the receiver (e.g., user equipment (UE)), minimizing interference, or supporting multiple users simultaneously.

### SUMMARY

According to one aspect of the present disclosure, a method to be performed by user equipment for CSI-RS estimation using a type I codebook is disclosed. In one aspect, the method can include receiving a channel state information reference signal (CSI-RS); and in response to receiving the CSI-RS, estimating CSI using a type I codebook, the type I codebook corresponds to a plurality of panels that are characterized by parameters N_{g}, N₁ and N₂. N_{g} indicates the number of the plurality of panels, N₁ indicates the number of antenna element locations per panel in vertical direction, and N₂ indicates the number of antenna element locations per panel in horizontal direction.

Other aspects include UE, apparatuses, systems, and computer programs for performing the aforementioned method.

The method can include other optional features. For example, in some implementations, each panel of the plurality of panels includes multiple CSI-RS ports, and the number of ports corresponding to the type I codebook is N_{g}×2×N₁×N₂.

In some implementations, the type I codebook is associated with up to 128 CSI-RS ports.

In some implementations, the method further includes transmitting CSI-RS feedback information in response to estimating the CSI.

In some implementations, each panel of the plurality of panels corresponds to one CSI-RS resource, and the one CSI-RS resource corresponds to a number of CSI-RS ports that is less than or equal to 32 CSI-RS ports.

In some implementations, each panel of the plurality of panels corresponds to multiple CSI-RS resources, and each of the multiple CSI-RS resources corresponds to a number of CSI-RS ports that is less than or equal to 32 CSI-RS ports.

In some implementations, estimating the CSI includes selecting a same spatial basis for each panel of the plurality of panels.

In some implementations, estimating the CSI includes independently selecting a spatial basis for each panel of the plurality of panels.

In some implementations, estimating the CSI includes selecting one spatial basis for each layer and for each panel of the plurality of panels.

In some implementations, estimating the CSI includes selecting multiple spatial bases for each layer and for each panel of the plurality of panels.

In some implementations, the CSI-RS feedback information includes a subband report including information of a plurality of frequency subbands, estimating the CSI includes selecting one spatial basis from the multiple spatial bases for each frequency subband.

In some implementations, the CSI-RS feedback information includes phase information of the CSI-RS with a horizontal polarization, the phase information includes quantized phase levels.

In some implementations, estimating the CSI includes assigning a unitary weighting factor for vertical polarization.

In some implementations, the phase information of the CSI-RS with the horizontal polarization includes a different phase level of each frequency subband.

In some implementations, the CSI-RS feedback information includes multiple precoding matrix indicators (PMIs) corresponding to the plurality of panels, the multiple PMIs have a same amplitude.

In some implementations, the CSI-RS feedback information includes an amplitude report indicating that each panel corresponds to a different amplitude.

In some implementations, the CSI-RS feedback information includes an amplitude report indicating that each frequency subband corresponds to a different amplitude.

According to another aspect of the present disclosure, a method to be performed by a UE for CSI-RS estimation using a type I codebook is disclosed. In one aspect, the method can include receiving a channel state information reference signal (CSI-RS) of a channel; and in response to receiving the CSI-RS, estimating CSI using a type I codebook, estimating the CSI includes setting one or more oversampling factors to a value, a rank of the channel is 5, 6, 7, or 8.

Other aspects include base stations, apparatuses, systems, and computer programs for performing the aforementioned method.

The method can include other optional features. For example, in some implementations, the type I codebook is associated with up to 128 CSI-RS ports.

In some implementations, the method further includes transmitting CSI-RS feedback information in response to estimating the CSI.

In some implementations, the one or more oversampling factors includes a first oversampling factor O₁ and a second oversampling factor O₂, the value is 4 .

In some implementations, the one or more oversampling factors includes a first oversampling factor O₁ and a second oversampling factor O₂, the value is 2.

In some implementations, the CSI-RS feedback information includes an oversampling factor selection report including the one or more oversampling factors equal to 2 or 4.

In some implementations, estimating the CSI further includes selecting one spatial basis for each pair of transmission layers.

In some implementations, estimating the CSI further includes selecting multiple spatial bases for each pair of transmission layers.

In some implementations, the CSI-RS feedback information includes a subband report including information of a plurality of frequency subbands, estimating the CSI further includes selecting one spatial basis from the multiple spatial bases for each frequency subband based on the subband report.

In some implementations, estimating the CSI further includes determining a first coefficient of a spatial basis associated with a vertical polarization for a pair of transmission layers, the first coefficient is 1.

In some implementations, estimating the CSI further includes determining a second coefficient of a spatial basis associated with a horizontal polarization for a first transmission layer in the pair of transmission layers, the second coefficient is e^{jϕ}, and ϕ is a quantized phase between 0 and 2π.

In some implementations, estimating the CSI further includes determining a third coefficient of a spatial basis associated with a horizontal polarization for a second transmission layer in the pair of transmission layers, wherein the third coefficient is −e^{jϕ}.

In some implementations, wherein the CSI-RS feedback information includes a first precoding matrix indicator (PMI) associated with a first rank≤4 and a second PMI associated with a second rank≤4.

In some implementations, when the rank is 5, the first rank is 3 and the second rank is 2.

In some implementations, when the rank is 6, the first rank is 3 and the second rank is 3.

In some implementations, when the rank is 7, the first rank is 4 and the second rank is 3.

In some implementations, when the rank is 8, the first rank is 4 and the second rank is 4.

In some implementations, the number of CSI-RS ports is P, the first PMI is determined based on P/2 CSI-RS ports, and the second PMI is determined based on remaining P/2 CSI-RS ports.

In some implementations, the number of CSI-RS ports is P, the first PMI and the second PMI are determined based on P CSI-RS ports.

In some implementations, the CSI-RS feedback information includes a first channel quality indicator (CQI) determined based on the first PMI and a second CQI determined based on the second PMI.

In some implementations, estimating the CSI further includes determining the same oversampling factors O₁ and O₂ for selecting orthogonal spatial bases, O₁≤3 and O₂≤3.

In some implementations, estimating the CSI further includes determining the same oversampling factors O₁ and O₂ for different transmission layers in either a vertical direction or a horizontal direction for selecting orthogonal spatial bases, O₁≤3 and O₂≤3.

In some implementations, estimating the CSI further includes selecting a different beam for each transmission layer.

According to another aspect of the present disclosure, a method to be performed by a UE for CSI-RS estimation using a type I codebook is disclosed. In one aspect, the method can include receiving a channel state information reference signal (CSI-RS); receiving a codebook subset restriction (CBSR) configuration including a soft amplitude restriction pᵢ for each spatial basis, 0≤pᵢ≤1, and i indicates i-th beam; and in response to receiving the CSI-RS, estimating CSI using a type I codebook and the CBSR configuration.

Other aspects include base stations, apparatuses, systems, and computer programs for performing the aforementioned method.

The method can include other optional features. For example, in some implementations, the type I codebook is associated with up to 128 CSI-RS ports.

In some implementations, estimating the CSI includes: when a rank is 1, determining a channel quality indicator (CQI) for each transmission layer; and selecting a spatial basis corresponding to the highest CQI.

In some implementations, the method further includes determining the CQI based on an assumption of a physical downlink shared channel (PDSCH) with a power corresponding to (Pᵢ)²×powerControlOffset.

In some implementations, the method includes, when a rank is greater than 1, determining a channel quality indicator (CQI) based on an assumption of a physical downlink shared channel (PDSCH) with a power corresponding to

$${( {p}_{i}^{l} )}^{2} \times powerControlOffset ,$$

wherein

$${p}_{i}^{l}$$

indicates a configured soft amplitude restriction corresponding to a selected spatial basis for a transmission layer l.

In some implementations, the method includes, when a rank is greater than 1, determining a channel quality indicator (CQI) based on an assumption of a physical downlink shared channel (PDSCH) with a power corresponding to a scale×powerControlOffset, the scale is the same for any transmission layer.

In some implementations, the scale is

$${min}_{l} \{ {( {p}_{i}^{l} )}^{2} \} ,$$

where

$${p}_{i}^{l}$$

indicates a configured soft amplitude restriction corresponding to a selected spatial basis for a transmission layer l.

In some implementations, the scale is

$${max}_{l} \{ {( {p}_{i}^{l} )}^{2} \} ,$$

where

$${p}_{i}^{l}$$

indicates a configured soft amplitude restriction corresponding to a selected spatial basis for a transmission layer l.

In some implementations, the scale is meanₗ

$$\{ {( {p}_{i}^{l} )}^{2} \}$$

or mediumₗ

$$\{ {( {p}_{i}^{l} )}^{2} \} ,$$

where

$${p}_{i}^{l}$$

indicates a configured soft amplitude restriction corresponding to a selected spatial basis for a transmission layer l.

In some implementations, the powerControlOffset is equally distributed among different transmission layers.

According to another aspect of the present disclosure, a UE including one or more processors is configured to perform operations of the above methods.

One or more processors including circuitry to execute one or more instructions that, when executed, cause a user equipment (UE) to perform operations of the above methods.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2 illustrates an example process of generating CSI-RS feedback information, according to some implementations.

FIG. 3 illustrates an example Type I codebook, according to some implementations.

FIG. 4 illustrates a plurality of example Type I codebooks, according to some implementations.

FIG. 5 illustrates a plurality of example Type I codebooks, according to some implementations.

FIG. 6 illustrates an example process of generating CSI-RS feedback information, according to some implementations.

FIG. 7 illustrates example oversampling factors determined for orthogonal spatial basis selection, according to some implementations.

FIG. 8 illustrates an example process of generating CSI-RS feedback information, according to some implementations.

FIG. 9 is a block diagram of an example UE, according to some implementations.

FIG. 10 is a block diagram of an example access node, according to some implementations.

FIG. 11 is a block diagram of an example apparatus, according to some implementations.

Like reference symbols in the various drawings indicate like elements.

### DETAILED DESCRIPTION

This disclosure describes methods and systems for enhancing a Type I codebook to support up to 128 Channel State Information Reference Signal (CSI-RS) ports across all CSI-RS resources (e.g., frequency-time resources).

In some implementations, the Type I codebook is enhanced to include multiple panels, with each panel including a subset of codebook entries. In some implementations, the Type I codebook is enhanced to support transmission scenarios with ranks 5, 6, 7, or 8. In some implementations, the Type I codebook is enhanced to enable Codebook Subset Restriction (CBSR) configuration.

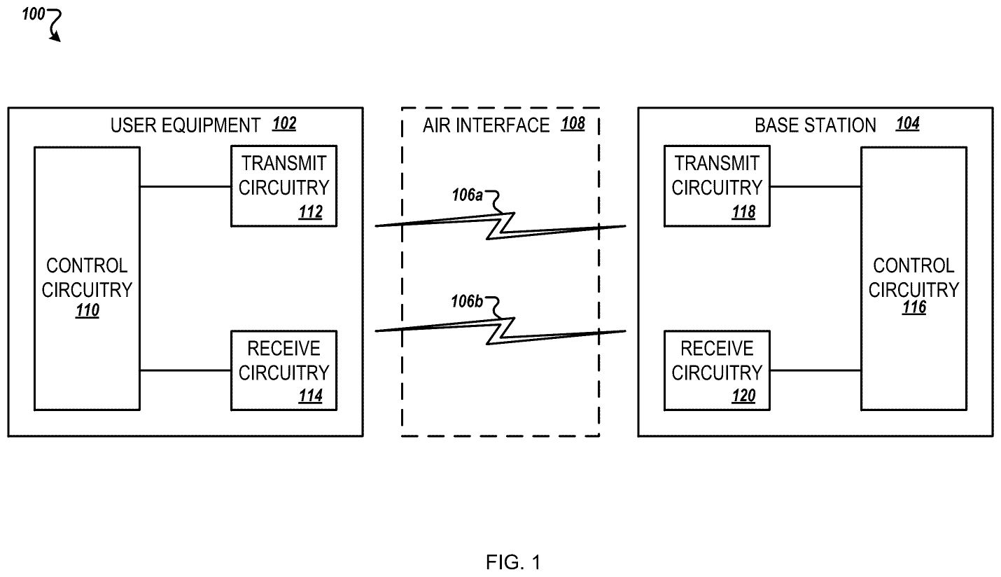

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be an E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE. For instance, the control circuitry 110 can estimate CSI in response to CSI-RS from the base station 104.

Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next-generation RAN, an E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

### Multiple Panels

In some implementations, the Type I codebook includes multiple panels to support up to 128 CSI-RS ports. A CSI-RS resource can be configured with more than 1 CSI-RS port. A CSI-RS port is used for transmitting CSI-RS signals from a base station to a UE. A multiple-panel structure is characterized by three parameters (N_{g}, N₁, N₂), where N_{g} is the number of panels, N₁ is the number of antenna element locations in a vertical direction for each panel, N₂ is the number of antenna element locations in a horizontal direction for each panel. An antenna element with vertical polarization (V-Pol) and an antenna element with horizontal polarization (H-Pol) are deployed at each antenna element location.

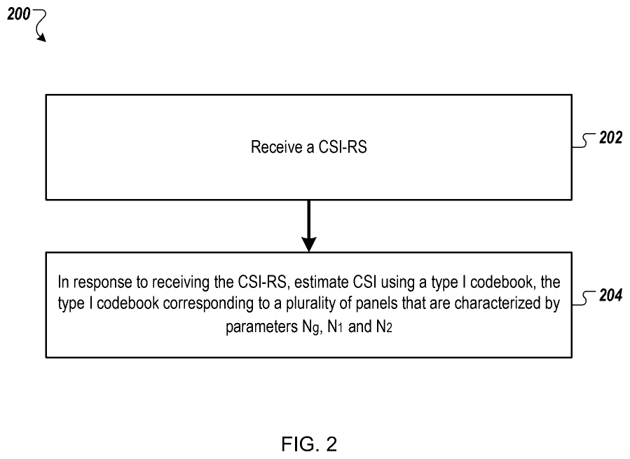

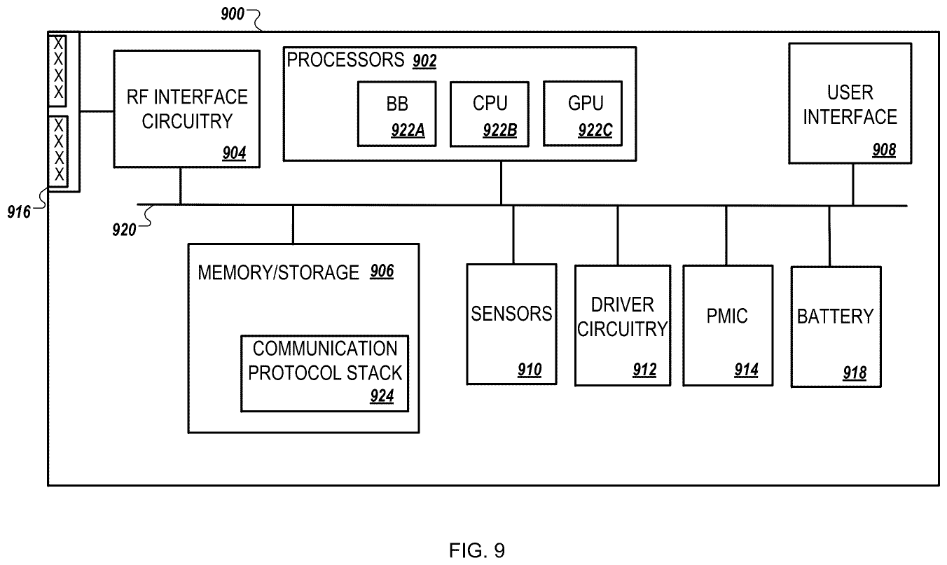

FIG. 2 illustrates an example process of generating CSI-RS feedback information, according to some implementations. The process 200 is described as being performed by a UE, such as UE 102 of FIG. 1 or UE 900 of FIG. 9. The example process 200 shown in FIG. 2 can be modified or reconfigured to include additional, fewer, or different steps (not shown in FIG. 2), which can be performed in the order shown or in a different order.

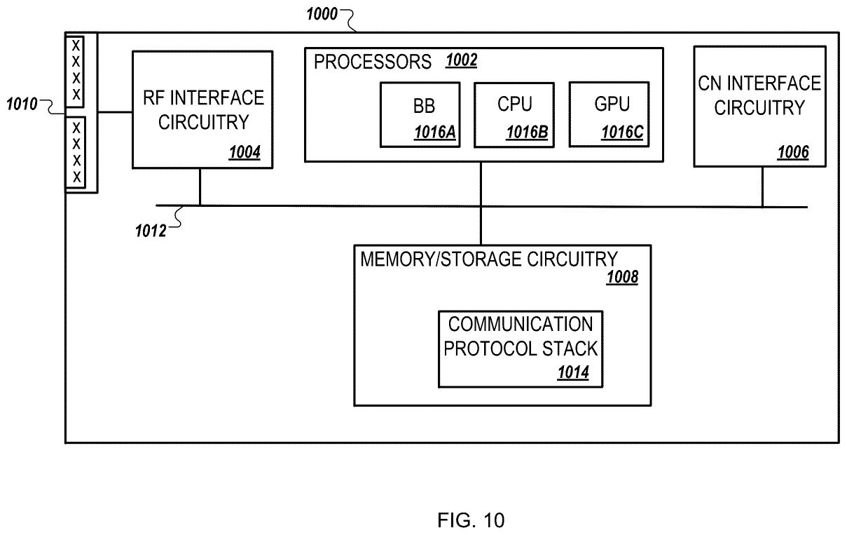

At 202, the UE receives a channel state information reference signal (CSI-RS). The CSI-RS can be received from a base station (e.g., base station 104 of FIG. 1 or access node 1000 of FIG. 10).

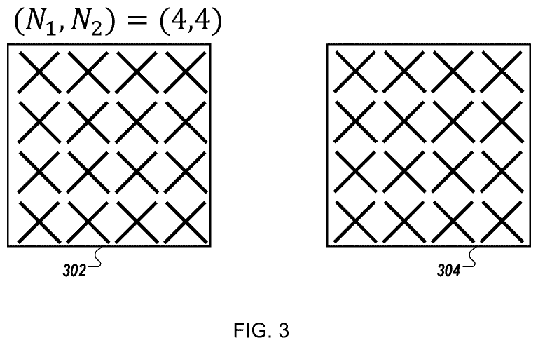

At 204, in response to receiving the CSI-RS, the UE estimates CSI using a type I codebook. The type I codebook (e.g., example type I codebooks of FIGS. 3, 4, and 5) corresponds to a plurality of panels that are characterized by parameters N_{g}, N₁ and N₂, where N_{g} indicates the number of the plurality of panels, N₁ indicates the number of antenna element locations per panel in vertical direction, and N₂ indicates the number of antenna element locations per panel in horizontal direction.

The type I codebook is associated with up to 128 CSI-RS ports. Each panel of the plurality of panels includes multiple CSI-RS ports. The total number of ports corresponding to the type I codebook is N_{g}×2×N₁×N₂. The UE transmits CSI-RS feedback information in response to estimating the CSI using the type I codebook. The UE transmits CSI-RS feedback information to the base station.

FIG. 3 illustrates an example Type I codebook, according to some implementations. As shown in FIG. 3, a Type I codebook characterized by (N_{g}, N₁, N₂)=(2, 4, 4) supports in total 64 CSI-RS ports. N_{g}=2 indicates that the Type I codebook includes 2 panels 302, 304. A linear antenna array (N₁, N₂)=(4,4) indicates that each panel corresponds to 32 CSI-RS ports. N₁=4 indicates 4 antenna element locations in a vertical direction. N₂=4 indicates 4 antenna element locations in a horizontal direction. Each panel 302, 304 corresponds to N₁×N₂=4×4=16 antenna element locations. There are 2 antenna elements deployed at each antenna element location. Accordingly, each panel 302, 304 corresponds to 16×2=32 antenna elements, which corresponds to 32 CSI-RS ports. In total, the Type I codebook corresponds to 32×N_{g}=32×2=64 CSI-RS ports.

In some implementations, the Type I codebook includes multiple panels and each panel maps to one CSI-RS resource, which refers to a single set of resource elements (a set of time-frequency resources) allocated for transmitting CSI-RS signals.

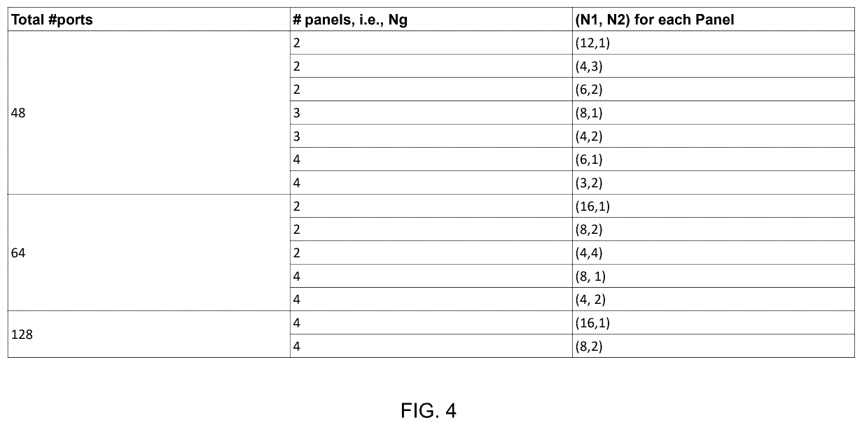

FIG. 4 illustrates a plurality of example Type I codebooks, according to some implementations. As shown in FIG. 4, the Type I codebook can support, e.g., 48 CSI-RS ports, 64 CSI-RS ports, or 128 CSI-RS ports. For example, the Type I codebook includes 4 panels (N_{g}=4), and each panel includes 16 antenna element locations (N₁=16) in a vertical direction and 1 antenna element location (N₂=1) in a horizontal direction. There are 2 antenna elements deployed at each antenna element location. In total, the Type I codebook can support N₁×N₂×2×N_{g}=16×1×2×4=128 CSI-RS ports. As another example, the Type I codebook includes 4 panels (N_{g}=4), and each panel includes 8 antenna element locations (N₁=8) in a vertical direction and 2 antenna element locations (N₂=2) in a horizontal direction. There are 2 antenna elements deployed at each antenna element location. In total, the Type I codebook can support N₁×N₂×2×N_{g}=8×2×2×4=128 CSI-RS ports.

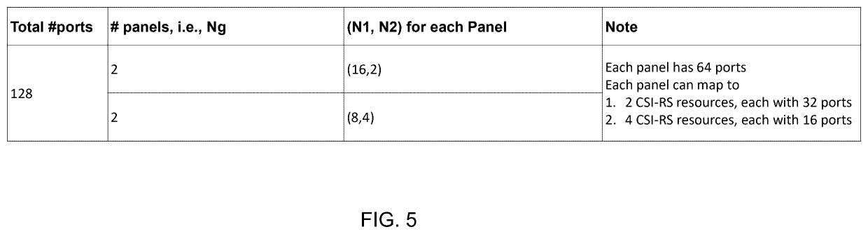

In some implementations, each panel maps to more than one CSI-RS resource. For example, each panel maps to two CSI-RS resources (two sets of time-frequency resources) or four CSI-RS resources (four sets of time-frequency resources) allocated for transmitting CSI-RS signals. FIG. 5 illustrates a plurality of example Type I codebooks, according to some implementations. As shown in FIG. 5, the Type I codebook can support 128 CSI-RS ports. For example, the Type I codebook includes 2 panels (N_{g}=2), and each panel includes 16 antenna element locations (N₁=16) in a vertical direction and 2 antenna element locations (N₂=2) in a horizontal direction. There are 2 antenna elements deployed at each antenna element location. Accordingly, each panel can support N₁×N₂×2=16×2×2 =64 CSI-RS ports. Each panel can map to 2 CSI-RS resources, each CSI-RS resource associated with 32 CSI-RS ports.

As another example, the Type I codebook includes 2 panels (N_{g}=2), and each panel includes 8 antenna element locations (N₁=8) in a vertical direction and 4 antenna element locations (N₂=4) in a horizontal direction. There are 2 antenna elements deployed at each antenna element location. Each panel can support N₁×N₂×2=8×4×2=64 CSI-RS ports. Each panel can map to 4 CSI-RS resources, each CSI-RS resource associated with 16 CSI-RS ports.

In some implementations, as to each transmission layer, the same spatial basis is selected for different panels. In some examples, as to each transmission layer, an independent/different spatial basis is selected for each panel. A spatial basis refers to a set of orthogonal vectors that represents the spatial characteristics of a Multiple-Input Multiple-Output (MIMO) channel, including spatial diversity, spatial multiplexing, and spatial correlation.

In some implementations, as to each transmission layer, one spatial basis is selected for each panel. In some examples, as to each transmission layer, a plurality of spatial bases are selected for each panel.

In some implementations, as to each transmission layer, a plurality of spatial bases are selected for each panel. A single spatial basis is selected, from the plurality of spatial bases, for each frequency subband. A frequency subband refers to a portion of the total bandwidth allocated for communication in the frequency domain.

In some implementations, a weighting factor is 1 for the selected spatial basis associated with vertical polarization. A weighting factor is used to adjust the magnitude of transmitted signals along a spatial direction or path (e.g., along the selected spatial basis). If the weighting factor is 1, it indicates that the signals are transmitted with full power along that spatial direction or path.

A quantized phase is reported in a co-phasing (weighting) report for the other polarization, e.g., a horizontal polarization. Phase quantization divides the continuous phase range into a finite number of discrete levels or bins. The co-phasing (weighting) report can be included in CSI feedback information transmitted from a UE to a base station. Co-phasing or weighting refers to adjusting the phase and/or amplitude of the received signals at different antennas to achieve a desired spatial combining or beamforming effect.

An independent/different phase can be reported, in a subband report, for each frequency subband associated with the horizontal polarization. A UE generates the subband report that summarizes the channel quality or conditions observed within each frequency subband and transmits the subband report to a base station. The subband report can be included in CSI feedback information transmitted from a UE to a base station.

In some implementations, the same amplitude of received signals is reported for different precoding matrix indicators (PMIs). In some examples, an independent/different amplitude can be reported for each panel. In some examples, as to each panel, an independent/different amplitude can be reported, in a subband report, for each frequency subband.

### Ranks 5-8 Transmission Scenarios

In some implementations, the Type I codebook is enhanced to support transmission scenarios with ranks 5, 6, 7, or 8. The “rank” of a communication channel refers to the maximum number of independent data streams that can be transmitted simultaneously without interference. For example, rank 5 transmission supports up to five independent data streams simultaneously. Rank 6 transmission supports up to six independent data streams simultaneously. Rank 7 transmission supports up to seven independent data streams simultaneously. Rank 8 transmission supports up to eight independent data streams simultaneously.

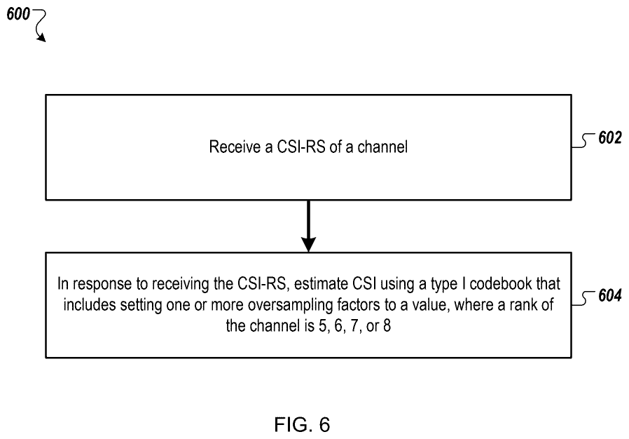

FIG. 6 illustrates an example process of generating CSI-RS feedback information, according to some implementations. The process 600 is described as being performed by a UE, such as UE 102 of FIG. 1 or UE 900 of FIG. 9. The example process 600 shown in FIG. 6 can be modified or reconfigured to include additional, fewer, or different steps (not shown in FIG. 6), which can be performed in the order shown or in a different order.

At 602, the UE receives a CSI-RS of a channel, e.g., from a base station (e.g., base station 104 of FIG. 1 or access node 1000 of FIG. 10).

At 604, in response to receiving the CSI-RS, the UE estimates CSI using a type I codebook. The type I codebook is associated with up to 128 CSI-RS ports. In CSI estimation, the UE sets one or more oversampling factors (e.g., oversampling factors (O₁, O₂)) to a value (e.g., 4 or 2). A rank of the channel is 5, 6, 7, or 8. The UE transmits CSI-RS feedback information in response to estimating the CSI.

In some examples, oversampling factors (O₁, O₂) for ranks 5, 6, 7, or 8 transmission scenarios can be selected as O₁=O₂=4, which are the same as oversampling factors for ranks 1, 2, 3, or 4 transmission scenarios. O₁ refers to an oversampling factor used for selecting spatial bases or precoding vectors in the first dimension of a MIMO communication system. O₁ represents the number of additional orthogonal vectors beyond the minimum required to achieve the desired rank or spatial diversity in the first dimension. O₂ refers to an oversampling factor used for selecting orthogonal spatial bases or precoding vectors in the second dimension of a MIMO communication system. Similar to O₁, O₂ represents the number of additional orthogonal vectors beyond the minimum required in the second dimension. The oversampling factors (O₁, O₂) are used to generate multiple groups of orthogonal spatial bases based on a Discrete Fourier Transform (DFT) matrix.

In some examples, oversampling factors (O₁, O₂) for ranks 5, 6, 7, or 8 transmission scenarios can be selected as O₁=O₂=2. The oversampling factor (O₁, O₂) selection can be reported in CSI part 2 of CSI feedback information.

The pair of oversampling factors (O₁, O₂) determines the resolution of beams used for spatial bases. Higher oversampling factors result in finer resolution beams, allowing for more precise steering of the transmitted signal to optimize signal transmission and reception. The beam has a higher resolution, which leads to a more complicated UE spatial basis search.

O₁=O₂=4 indicates that there are 4 times (2 times for each direction, e.g., 2 times for a vertical direction and 2 times for a horizontal direction) number of beams for spatial bases compared to O₁=O₂=2.

O₁ and O₂ are determined (e.g., configured by the network or hardcoded in a 3GPP standard specification), as a part of spatial basis selection. The UE selects one pair of oversampling factors (O₁,O₂). For example, if O₁=O₂4, there are 4 possible oversampling factors (0, 1, 2, 3) in each direction (a vertical direction and a horizontal direction), resulting in 16 pairs of oversampling factors, e.g., (0, 0), (0, 1), (0, 2), (0, 3), (1, 0), (1, 1), (1, 2), (1, 3), (2, 0), (2, 1), (2, 2), (2, 3), (3, 0), (3, 1), (3, 2), or (3, 3). The UE selects one pair from the 16 pairs of oversampling factors. The oversampling factor selection report includes selecting one of the 16 pairs. In some implementations, the UE performs a more complicated search of spatial bases for a higher rank (more transmission layers). Lower oversampling factors O₁=O₂=2 can be used for rank 5, 6, 7, or 8 to reduce UE CSI computation complexity. In some implementations, higher oversampling factors O₁=O₂=4 can be used for rank 5, 6, 7, or 8 to obtain a higher resolution PMI at the cost of higher UE computational complexity.

In some implementations, an independent/different spatial basis can be selected for each pair of transmission layers associated with codebook 1. The codebook structure 1 refers to a predefined set of beamforming or precoding vectors that are designed to optimize certain performance metrics or criteria. In some examples, a single spatial basis is selected for each pair of transmission layers. In some examples, a plurality of spatial bases (L>1) are selected for each pair of transmission layers.

In some implementations, if a plurality of spatial bases are selected, a single spatial basis is selected, from the plurality of spatial bases, for each frequency subband. A UE generates the subband report that summarizes the channel quality or conditions observed within each frequency subband and transmits the subband report to a base station. The subband report can be included in CSI feedback information transmitted from a UE to a base station.

In some implementations, as to a pair of transmission layers, a coefficient of a spatial basis associated with vertical polarization is selected as 1 for both layers. As to the first transmission layer in the pair of transmission layers, a coefficient of the spatial basis associated with a horizontal polarization is reported as e^{jϕ}, where ϕ is a quantized phase uniformly between 0 and 2π. As to the second transmission layer in the pair of transmission layers, a coefficient of the spatial basis associated with a horizontal polarization is assumed (not reported) as −e^{jϕ} based on the report of the first transmission layer.

In some implementations, two PMIs associated with codebook structure 2 are respectively reported for two transmission scenarios with a rank<=4. If rank=5, one PMI is reported in a transmission scenario having a rank=3, and the other PMI is reported for a transmission scenario having a rank=2. If rank=6, one PMI is reported in a transmission scenario having a rank=3, and the other PMI is reported for a transmission scenario having a rank=3. If rank=7, one PMI is reported for a transmission scenario having a rank=4, and the other PMI is reported for a transmission scenario having a rank=3. If rank=8, one PMI is reported for a transmission scenario having a rank=4, and the other PMI is reported for a transmission scenario having a rank=4. The codebook structure 2 represents another set of predefined beamforming or precoding vectors, distinct from the beamforming or precoding vectors in codebook structure 1.

In some examples, two PMIs are calculated based on different sets of CSI-RS ports, respectively. For example, the first PMI is calculated based on the first P/2 CSI-RS ports, while the second PMI is calculated based on the remaining P/2 CSI-RS ports. “P” represents the total number of CSI-RS ports available in a base station. In some examples, two PMIs are calculated based on the same CSI-RS ports. For example, both the first PMI and the second PMI are calculated based on the same P CSI-RS ports.

In some examples, two channel quality indicators (CQIs) are reported in CSI feedback information. The first CQI is calculated based on the first PMI, while the second CQI is calculated based on the second PMI.

In option 1, to ensure the selection of orthogonal spatial bases, orthogonal spatial bases are selected with the same pair of oversampling factors (O₁, O₂) for different transmission layers. O₁≤3 and O₂≤3. The pair of oversampling factors (O₁, O₂) can be selected from (0, 0), (0, 1), (0, 2), (0, 3), (1, 0), (1, 1), (1, 2), (1, 3), (2, 0), (2, 1), (2, 2), (2, 3), (3, 0), (3, 1), (3, 2), or (3, 3). Different transmission layers have the same pair of oversampling factors.

In option 2, orthogonal spatial bases are selected with independent/different oversampling factors (O₁, O₂) for each transmission layer. Each transmission layer has an independent pair of oversampling factors (each transmission layer can have the same pair of oversampling factors, or a different pair of oversampling factors). Orthogonal spatial bases can be ensured if the same oversampling factors are selected at least either in a vertical direction or a horizontal direction for different transmission layers, or selected in both the vertical direction and the horizontal direction. An independent/different beam is selected for each transmission layer if the same pair of oversampling factors is selected.

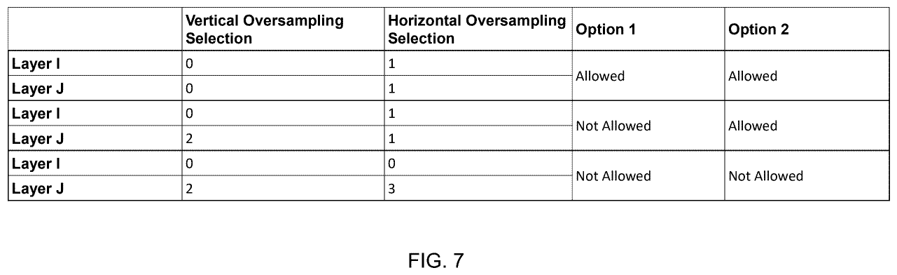

FIG. 7 illustrates example oversampling factors determined for orthogonal spatial basis selection, according to some implementations. As shown in FIG. 7, in an example, a pair of oversampling factors is (0,1) for Layer I, and a pair of oversampling factors is (0,1) for Layer J. Layer I and Layer J have the same pair of oversampling factors is (0,1), which is an example of option 1 and option 2. As another example, a pair of oversampling factors is (0,1) for Layer I, and a pair of oversampling factors is (2,1) for Layer J. Layer I and Layer J have different pairs of oversampling, while the oversampling factor for Layer I and Layer J in a horizontal direction is the same (the oversampling factor is 1 in a horizontal direction), which is an example of option 2. As another example, a pair of oversampling factors is (0,0) for Layer I, and a pair of oversampling factors is (2,3) for Layer J. Layer I and Layer J have different pairs of oversampling, and the oversampling factors in a horizontal direction and in a vertical direction are also different, which is neither an example of option 1 nor an example of option 2.

### Codebook Subset Restriction (CBSR) Configuration

CBSR is used to restrict the set of precoding vectors or beamforming weights that can be selected by a base station (e.g., eNodeB or gNB) from a full codebook.

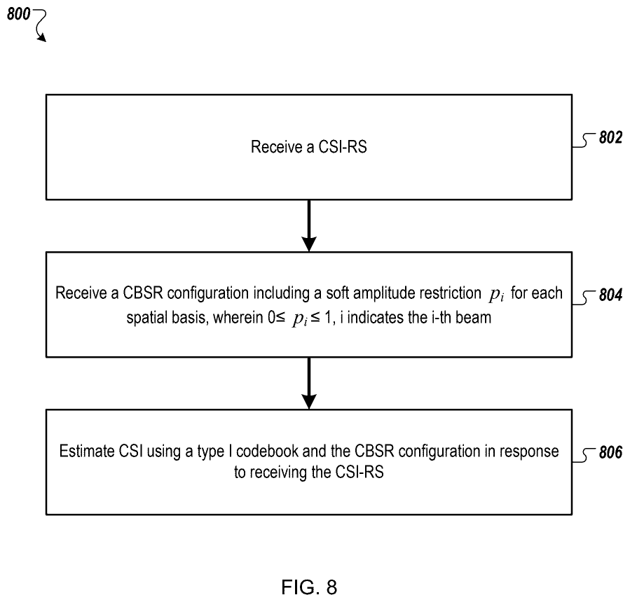

FIG. 8 illustrates an example process of generating CSI-RS feedback information, according to some implementations. The process 800 is described as being performed by a UE, such as UE 102 of FIG. 1 or UE 900 of FIG. 9. The example process 800 shown in FIG. 8 can be modified or reconfigured to include additional, fewer, or different steps (not shown in FIG. 8), which can be performed in the order shown or in a different order.

At 802, the UE receives a CSI-RS, e.g., from a base station (e.g., base station 104 of FIG. 1 or access node 1000 of FIG. 10).

At 804, the UE receives a codebook subset restriction (CBSR) configuration including a soft amplitude restriction p; for each spatial basis, where 0≤pᵢ≤1, and i indicates the i-th beam.

At 806, in response to receiving the CSI-RS, the UE estimates CSI using a type I codebook and the CBSR configuration.

When rank=1, the UE determines a CQI based on an assumption of a PDSCH with a power corresponding to (Pᵢ)²×powerControlOffset. When rank>1, the UE determines a CQI based on an assumption of a physical downlink shared channel (PDSCH) with a power corresponding to a scale factor×powerControlOffset. In some examples, the scale factor is

$${( {p}_{i}^{l} )}^{2} and {p}_{i}^{l}$$

indicates a configured soft amplitude restriction corresponding to the selected spatial basis for a transmission layer l. The configured PDSCH power is powerControlOffset, which is scaled by

$${( {p}_{i}^{l} )}^{2}$$

In some examples, the scale is

$${min}_{l} \{ {( {p}_{i}^{l} )}^{2} \} .$$

The configured PDSCH power is powerControlOffset, which is scaled by

$${min}_{l} \{ {( {p}_{i}^{l} )}^{2} \} .$$

In some examples, the scale is

$${max}_{l} \{ {( {p}_{i}^{l} )}^{2} \} .$$

The configured PDSCH power is powerControlOffset, which is scaled by

$${max}_{l} \{ {( {p}_{i}^{l} )}^{2} \} .$$

In some examples, the scale is meanₗ

$$\{ {( {p}_{i}^{l} )}^{2} \}$$

or mediumₗ

$$\{ {( {p}_{i}^{l} )}^{2} \} .$$

The configured PUSCH power is powerControlOffset, which is scaled by meanₗ

$$\{ {( {p}_{i}^{l} )}^{2} \}$$

or mediumₗ

$$\{ {( {p}_{i}^{l} )}^{2} \} .$$

In some implementations, soft amplitude restriction is configured for each spatial basis. The soft amplitude restriction refers to a technique used to limit the magnitude or power of the precoding vectors or beamforming weights selected from the codebook for each spatial basis. A soft amplitude restriction is denoted as 0≤pᵢ≤1 for the i-th beam.

In some implementations, in a transmission scenario having a rank=1, a UE can determine CQI for each transmission layer and identify the best spatial basis corresponding to the highest CQI. The Physical Downlink Shared Channel (PDSCH) power for signal transmission is the configured PDSCH power (powerControlOffset) scaled by (pᵢ)²=powerControlOffset×(pᵢ)². The powerControlOffset allows for the adjustment of a power level of the PDSCH transmission relative to a reference power level. According to 3GPP TS 38.214, powerControlOffset is an assumed ratio of PDSCH EPRE to NZP CSI-RS EPRE when UE derives CSI feedback and takes values in the range of [18 15] dB with 1 dB step size.

In some implementations, in a transmission scenario with a rank>1, rank selection, spatial basis selection, and CQI calculation are performed. In some examples, when a single spatial basis is selected for each transmission layer, the configured PDSCH power is scaled by the corresponding

$${( {p}_{i}^{l} )}^{2} , {p}_{i}^{l}$$

is selected spatial basis for transmission layer l. In some examples, the same scale can be applied to all the transmission layers based on

$${p}_{i}^{l}$$

of each transmission layer. For example, the minimum scale, i.e.,

$${min}_{l} \{ {( {p}_{i}^{l} )}^{2} \}$$

can be applied to all the transmission layers. As another example, the maximum scale, i.e.

$${max}_{l} \{ {( {p}_{i}^{l} )}^{2} \}$$

can be applied to all transmission layers. As another example, the mean or medium scale, i.e.,

$${mean}_{l} \{ {( {p}_{i}^{l} )}^{2} \} or {medium}_{l} \{ {( {p}_{i}^{l} )}^{2} \}$$

can be applied to all the transmission layers. Each transmission layer is assumed to have equal power splitting among the configured PDSCH power (powerControlOffset) before scaling. The total PDSCH power allocated for the PDSCH transmission is divided equally among the transmission layers.

FIG. 9 illustrates an example UE 900, according to some implementations. The UE 900 may be similar to and substantially interchangeable with UE 102 of FIG. 1.

The UE 900 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 900 may include processors 902, RF interface circuitry 904, memory/storage 906, user interface 908, sensors 910, driver circuitry 912, power management integrated circuit (PMIC) 914, one or more antenna(s) 916, and battery 918. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangements of the components shown may occur in other implementations.

The components of the UE 900 may be coupled with various other components over one or more interconnects 920, which may represent any type of interface, input/output, bus (local, system, or expansion), transmission line, trace, optical connection, etc., that allows various circuit components (on common or different chips or chipsets) to interact with one another.

The processors 902 may include processor circuitry such as, for example, baseband processor circuitry (BB) 922A, central processor unit circuitry (CPU) 922B, and graphics processor unit circuitry (GPU) 922C. The processors 902 may include any type of circuitry or processor circuitry that executes or otherwise operates computer-executable instructions, such as program code, software modules, or functional processes from memory/storage 906 to cause the UE 900 to perform operations as described herein.

In some implementations, the baseband processor circuitry 922A may access a communication protocol stack 924 in the memory/storage 906 to communicate over a 3GPP compatible network. In general, the baseband processor circuitry 922A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 904. The baseband processor circuitry 922A may generate or process baseband signals or waveforms that carry information in 3GPP-compatible networks. In some implementations, the waveforms for NR may be based on cyclic prefix orthogonal frequency division multiplexing (OFDM) “CP-OFDM” in the uplink or downlink, and discrete Fourier transform spread OFDM “DFT-S-OFDM” in the uplink.

The memory/storage 906 may include one or more non-transitory, computer-readable media that includes instructions (for example, communication protocol stack 924) that may be executed by one or more of the processors 902 to cause the UE 900 to perform various operations described herein. The memory/storage 906 includes any type of volatile or non-volatile memory that may be distributed throughout the UE 900. In some implementations, some of the memory/storage 906 may be located on the processors 902 themselves (for example, L1 and L2 cache), while other memory/storage 906 is external to the processors 902 but accessible thereto via a memory interface. The memory/storage 906 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 904 may include transceiver circuitry and radio frequency front module (RFEM) that allows the UE 900 to communicate with other devices over a radio access network. The RF interface circuitry 904 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 916 and proceed to filter and amplify (with a low-noise amplifier) the signal. The signal may be provided to a receiver of the transceiver that downconverts the RF signal into a baseband signal that is provided to the baseband processor of the processors 902.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 916. In various implementations, the RF interface circuitry 904 may be configured to transmit/receive signals in a manner compatible with NR access technologies.

The antenna(s) 916 may include one or more antenna elements to convert electrical signals into radio waves to travel through the air and to convert received radio waves into electrical signals. The antenna elements may be arranged into one or more antenna panels. The antenna(s) 916 may have antenna panels that are omnidirectional, directional, or a combination thereof to enable beamforming and multiple input, multiple output communications. The antenna(s) 916 may include microstrip antennas, printed antennas fabricated on the surface of one or more printed circuit boards, patch antennas, phased array antennas, etc. The antenna(s) 916 may have one or more panels designed for specific frequency bands including bands in FR1 or FR2.

The user interface 908 includes various input/output (I/O) devices designed to enable user interaction with the UE 900. The user interface 908 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 900.

The sensors 910 may include devices, modules, or subsystems whose purpose is to detect events or changes in their environment and send the information (sensor data) about the detected events to some other device, module, subsystem, etc. Examples of such sensors include, inter alia, inertia measurement including accelerometers, gyroscopes, or magnetometers; microelectromechanical nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 912 may include software and hardware elements that operate to control particular devices that are embedded in the UE 900, attached to the UE 900, or otherwise communicatively coupled with the UE 900. The driver circuitry 912 may include individual drivers allowing other components to interact with or control various input/output (I/O) devices that may be present within, or connected to, the UE 900. For example, driver circuitry 912 may include a display driver to control and allow access to a display device, a touchscreen driver to control and allow access to a touchscreen interface, sensor drivers to obtain sensor readings of sensors 910 and control and allow access to sensors 910, drivers to obtain actuator positions of electro-mechanic components or control and allow access to the electro-mechanic components, a camera driver to control and allow access to an embedded image capture device, audio drivers to control and allow access to one or more audio devices.

The PMIC 914 may manage power provided to various components of the UE 900. In particular, with respect to the processors 902, the PMIC 914 may control power-source selection, voltage scaling, battery charging, or DC-to-DC conversion.

In some implementations, the PMIC 914 may control, or otherwise be part of, various power saving mechanisms of the UE 900. A battery 918 may power the UE 900, although in some examples the UE 900 may be mounted deployed in a fixed location, and may have a power supply coupled to an electrical grid. The battery 918 may be a lithium ion battery, a metal-air battery, such as a zinc-air battery, an aluminum-air battery, a lithium-air battery, and the like. In some implementations, such as in vehicle-based applications, the battery 918 may be a typical lead-acid automotive battery.

FIG. 10 illustrates an example access node 1000 (e.g., a base station or gNB), according to some implementations. The access node 1000 may be similar to and substantially interchangeable with base station 104. The access node 1000 may include processors 1002, RF interface circuitry 1004, core network (CN) interface circuitry 1006, memory/storage circuitry 1008, and one or more antenna(s) 1010.

The components of the access node 1000 may be coupled with various other components over one or more interconnects 1012. The processors 1002, RF interface circuitry 1004, memory/storage circuitry 1008 (including communication protocol stack 1014), antenna(s) 1010, and interconnects 1012 may be similar to like-named elements shown and described with respect to FIG. 9. For example, the processors 1002 may include processor circuitry such as, for example, baseband processor circuitry (BB) 1016A, central processor unit circuitry (CPU) 1016B, and graphics processor unit circuitry (GPU) 1016C.

The CN interface circuitry 1006 may provide connectivity to a core network, for example, a 5th Generation Core network (5GC) using a 5GC-compatible network interface protocol such as carrier Ethernet protocols, or some other suitable protocol. Network connectivity may be provided to/from the access node 1000 via a fiber optic or wireless backhaul. The CN interface circuitry 1006 may include one or more dedicated processors or FPGAs to communicate using one or more of the aforementioned protocols. In some implementations, the CN interface circuitry 1006 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1000 that operates in an NR or 5G system (for example, a gNB), and the term “E-UTRAN node” or the like may refer to an access node 1000 that operates in an LTE or 4G system (e.g., an eNB). According to various implementations, the access node 1000 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1000 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 1000; a MAC/PHY split wherein RRC, PDCP, RLC, and MAC layers are operated by the CRAN/vBBUP and the PHY layer is operated by the access node 1000; or a “lower PHY” split wherein RRC, PDCP, RLC, MAC layers and upper portions of the PHY layer are operated by the CRAN/vBBUP and lower portions of the PHY layer are operated by the access node 1000.

In V2X scenarios, the access node 1000 may be or act as RSUs. The term “RoadSide Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

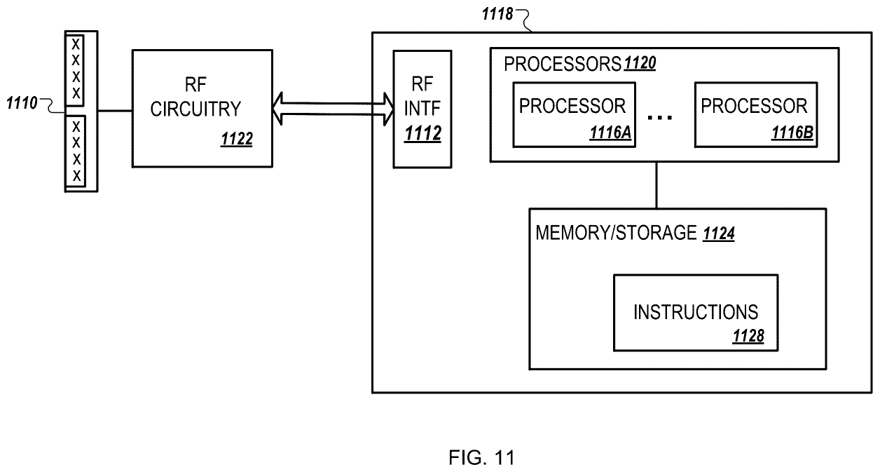

FIG. 11 is a block diagram of an example apparatus 1100, according to some implementations. In some implementations, the apparatus 1100 includes a baseband processor circuitry. For example, the apparatus 1100 may be similar to the baseband processor circuitry (BB) 922A of FIG. 9 or the baseband processor circuitry (BB) 1016A of FIG. 10 in some cases.

As shown, the apparatus 1100 includes one or more processors 1116A and 1116B, and memory/storage 1108 storing instructions 1114 that are executed by the one or more processors 1116A and 1116B. Although FIG. 11 illustrates the apparatus 1100 as having multiple processors, in some cases the apparatus 1100 can include a single processor (e.g., one of processor 1116A or processor 1116B).

The apparatus 1100 is electrically and communicatively coupled, through RF interface 1112, to RF circuitry 1104 and associated antenna structure 1110. In some implementations, one or more of the processors 1116A and 1116B execute the instructions 1114 to control communications through the RF interface circuitry 1104 and antenna structure 1110. For example, the one or more processors 1116A and 1116B may execute the instructions 1114 to generate or process baseband signals or waveforms that carry information using wireless channels, and/or manage the radio functions of RF circuitry 1104 and antenna structure 1110, such as signal modulation, encoding, radio frequency shifting, in addition or as an alternative to the user plane or control plane functions as described with respect to the baseband processor circuitry (BB) 922A of FIG. 9 and the baseband processor circuitry (BB) 1016A of FIG. 10. In doing so, the apparatus 1100 enables communication, e.g., wireless cellular communication, over a 3GPP compatible network.

Additionally, in some implementations, the apparatus 1100 may include wireless hardware connectivity interface(s) to send/receive data to/from Near Field Communication (NFC) components, Bluetooth® components (e.g., Bluetooth® Low Energy), Wi-Fi® components, and other communication components, and a power management interface (e.g., an interface to send/receive power). In such implementations, the instructions 1114 may include instructions that, when executed by one or more of the processors 1116A and 1116B, cause these processors to perform Wi-Fi communications on an 802.11 network, and/or perform Bluetooth communications.

In some implementations, one or more of the processors 1116A and 1116B is a 3G baseband processor, a 4G baseband processor, a 5G baseband processor, or other suitable baseband processor. In some implementations, one or more of the processors 1116A and 1116B may be configured as an FPGA (Field Programmable Gate Array), and/or may have dedicated hardware components, which may include an ASIC (Application Specific Integrated Circuit).

Various components may be described as performing a task or tasks, for convenience in the description. Such descriptions should be interpreted as including the phrase “configured to.” Reciting a component that is configured to perform one or more tasks is expressly intended not to invoke 35 USC § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following section, further exemplary implementations are provided.

Example 1 includes a method, including: receiving a channel state information reference signal (CSI-RS); and in response to receiving the CSI-RS, estimating CSI using a type I codebook, wherein the type I codebook corresponds to a plurality of panels, and wherein each panel of the plurality of panels corresponds to one CSI-RS resource.

Example 2 is the method of Example 1, wherein the plurality of panels that are characterized by parameters N_{g}, N₁ and N₂, wherein N_{g} indicates a number of the plurality of panels, N₁ indicates a number of antenna element locations per panel in vertical direction, and N₂ indicates a number of antenna element locations per panel in horizontal direction.

Example 3 is the method of Example 2, wherein each panel of the plurality of panels comprises multiple CSI-RS ports, and wherein a number of ports corresponding to the type I codebook is N_{g}×2×N₁×N₂.

Example 4 is the method of any one of Examples 1-3, wherein the type I codebook is associated with up to 128 CSI-RS ports.

Example 5 is the method of any one of Examples 1-4, further comprising transmitting CSI-RS feedback information in response to estimating the CSI.

Example 6 is the method of any one of Examples 1-5, wherein the one CSI-RS resource corresponds to a number of CSI-RS ports that is less than or equal to 32 CSI-RS ports.

Example 7 is the method of any one of Examples 1-6, wherein a rank of the channel is 1, 2, 3, or 4.

Example 8 includes a method, including: receiving a channel state information reference signal (CSI-RS); and in response to receiving the CSI-RS, estimating CSI using a type I codebook, wherein estimating the CSI comprises independently selecting a spatial basis for each panel of the plurality of panels.

Example 9 includes a method, including: receiving a channel state information reference signal (CSI-RS); and in response to receiving the CSI-RS, estimating CSI using a type I codebook, wherein estimating the CSI comprises selecting one spatial basis for each layer and for each panel of the plurality of panels.

Example 10 includes a method, including: receiving a channel state information reference signal (CSI-RS) of a channel; and in response to receiving the CSI-RS, estimating CSI using a type I codebook, wherein estimating the CSI comprises: independently selecting a spatial basis for each pair of transmission layers, wherein a rank of the channel is 5, 6, 7, or 8.

Example 11 is the method of Example 10, wherein the type I codebook is associated with up to 128 CSI-RS ports.

Example 12 is the method of Example 10 or 11, the method further comprising transmitting

CSI-RS feedback information in response to estimating the CSI.

Example 13 is the method of any one of Examples 10-12, wherein independently selecting a spatial basis for each pair of transmission layers comprises selecting one spatial basis for each pair of transmission layers.

Example 14 includes a user equipment (UE) comprising one or more processors configured to perform operations of any one of method Examples 1-13.

Example 15 includes one or more processors comprising circuitry to execute one or more instructions that, when executed, cause a user equipment (UE) to perform operations of any one of method Examples 1-13.

Example 16 includes an apparatus including: one or more processors; and one or more memory devices storing instructions that, when executed, cause the one or more processors to perform operations of any one of method Examples 1-13.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A method, comprising:
receiving a channel state information reference signal (CSI-RS); and
in response to receiving the CSI-RS, estimating CSI using a type I codebook, wherein the type I codebook corresponds to a plurality of panels that are characterized by parameters N_{g}, N₁ and N₂, wherein
N_{g} indicates a number of the plurality of panels,
N₁ indicates a number of antenna element locations per panel in a vertical direction, and
N₂ indicates a number of antenna element locations per panel in a horizontal direction.

2. The method of claim 1, wherein each panel of the plurality of panels comprises multiple CSI-RS ports, and wherein a number of ports corresponding to the type I codebook is N_{g}×2×N₁×N₂.

3. The method of claim 2, wherein the type I codebook is associated with up to 128 CSI-RS ports.

4. The method of claim 1, further comprising transmitting CSI-RS feedback information in response to estimating the CSI.

5. The method of claim 1, wherein each panel of the plurality of panels corresponds to one CSI-RS resource, and the one CSI-RS resource corresponds to a number of CSI-RS ports that is less than or equal to 32 CSI-RS ports.

6. The method of claim 1, wherein each panel of the plurality of panels corresponds to multiple CSI-RS resources, and wherein each of the multiple CSI-RS resources corresponds to a number of CSI-RS ports that is less than or equal to 32 CSI-RS ports.

7. The method of claim 1, wherein estimating the CSI comprises selecting a same spatial basis for each panel of the plurality of panels.

8. The method of claim 1, wherein estimating the CSI comprises independently selecting a spatial basis for each panel of the plurality of panels.

9. The method of claim 1, wherein estimating the CSI comprises selecting one spatial basis for each layer and for each panel of the plurality of panels.

10. The method of claim 4, wherein estimating the CSI comprises selecting multiple spatial bases for each layer and for each panel of the plurality of panels.

11. The method of claim 10, wherein the CSI-RS feedback information comprises a subband report comprising information of a plurality of frequency subbands, estimating the CSI comprises selecting one spatial basis from the multiple spatial bases for each frequency subband.

12. The method of claim 11, wherein estimating the CSI comprises assigning a unitary weighting factor for vertical polarization.

13. The method of claim 11, wherein phase information of the CSI-RS with horizontal polarization comprises a different phase level of each frequency subband.

14. The method of claim 4, wherein the CSI-RS feedback information comprises multiple precoding matrix indicators (PMIs) corresponding to the plurality of panels, wherein the multiple PMIs have a same amplitude.

15. The method of claim 4, wherein the CSI-RS feedback information comprises an amplitude report indicating that each panel corresponds to a different amplitude.

16. The method of claim 4, wherein the CSI-RS feedback information comprises an amplitude report indicating that each frequency subband corresponds to a different amplitude.

17. An apparatus comprising one or more processors configured to perform operations comprising:
receiving a channel state information reference signal (CSI-RS); and
in response to receiving the CSI-RS, estimating CSI using a type I codebook, wherein the type I codebook corresponds to a plurality of panels that are characterized by parameters N_{g}, N₁ and N₂, wherein
N_{g} indicates a number of the plurality of panels,
N₁ indicates a number of antenna element locations per panel in a vertical direction, and
N₂ indicates a number of antenna element locations per panel in a horizontal direction.

18. The apparatus of claim 17, wherein each panel of the plurality of panels comprises multiple CSI-RS ports, and wherein a number of ports corresponding to the type I codebook is N_{g}×2×N₁×N₂.

19. One or more processors comprising circuitry to execute one or more instructions that, when executed, cause an apparatus to perform operations comprising:
receiving a channel state information reference signal (CSI-RS); and
in response to receiving the CSI-RS, estimating CSI using a type I codebook, wherein the type I codebook corresponds to a plurality of panels that are characterized by parameters N_{g}, N₁ and N₂, wherein
N_{g} indicates a number of the plurality of panels,
N₁ indicates a number of antenna element locations per panel in a vertical direction, and
N₂ indicates a number of antenna element locations per panel in a horizontal direction.

20. The one or more processors of claim 19, wherein each panel of the plurality of panels comprises multiple CSI-RS ports, and wherein a number of ports corresponding to the type I codebook is N_{g}×2×N₁×N₂.
